(19) United States
(12) Patent Application Publication
(10) Pub. No.: US 2006/0071999 A1
(43) Pub. Date: Apr. 6, 2006

(54) Cue sports cloth and method of pringting cue sports cloth

(76) Inventors: Stephen John Lobley, Dudbridge (GB); Alan John Brasier, Eastington (GB)

Correspondence Address: Jeffery E Bacon;Milliken & company M-495, 920 Milliken Road, P O Box 1926, Spartanburg, SC, 29304, US

(21) Appl. No.: 10/521,486

(22) PCT Filed: Jul. 8, 2003
(86) PCT No.: PCT/GB03/02940

§ 371 Date: Sep. 6, 2005

(30) Foreign Application Priority Data
Jul. 25, 2002 (GB) 0217231.0

(51) Int. Cl. B41J 2/01

(52) U.S. Cl. 347/105

(57) ABSTRACT

A cue sports cloth comprises a cloth with a playing surface having a design printed thereon. At least 30% of the area of the playing surface is printed with a camouflage design as defined by the function ΔE₂<kΔE₁, where ΔE, is a measure of complexity of the design, ΔE₂ is a measure of the similarity of the colour contrast of the design with respect to the base colour k is a constant with a value in the range 0 to 5.

This invention relates to a cue sports cloth and a method of printing a cue sports cloth. The invention also relates to a cue sports table fitted with the cloth.

In the present specification, the term “cue sports cloth” means a cloth that is intended for covering the playing surface of a cue sports table, for example a pool, snooker or billiards table.

Cue sports cloths may be woven, felted or unfelted, or non-woven and maybe fabricated from a range of fibres including wool, nylon and mixtures thereof. The best playing surface is widely considered to be obtained by use of a woven, felted woollen cloth with a raised nap. The next best surface is considered to be a worsted fabric made from a wool/nylon blend, usually with up to 40% nylon.

Traditionally, cue sports cloth is dyed in the bulk to a uniform colour. The colour depends on the game being played and local preferences, green and blue cloths being common.

Recently, there has been a trend towards printed cloths that include some sort of pattern or design. This may be to allow the cloth to carry an advertising or promotional logo, or simply to provide an unusual or custom appearance.

Printed woollen cloths have for some time been used as gaming table covers in casinos. For those purposes it is common practice to print a games layout on the surface of the cloth: for example, images of playing cards may be printed onto the cloth. This is done by discharge silk screen printing onto the already dyed cloth, as described in GB 2311079. This is a costly and time-consuming process as each colour must be printed separately, using a different screen for each colour. The process is also only suitable for relatively simple designs, having only a few colours.

It has also been proposed in U.S. Pat. No. 5,568,666 to roller print a single colour onto the surface of undyed nylon cloth for use on pool tables.

In order to produce designs with more colours and/or subtle shades of colour, other printing methods are required. One possibility is to use a sublimatic printing process in which sublimatic dyes are transferred from a printed transfer paper onto the undyed cloth under heat and pressure. However, the sublimatic dyes presently available are not compatible with wool fibres and therefore, for the process to work, the cloth must contain a substantial proportion of dye-compatible fibres, for example polyester fibres. Even then, if the cloth is a wool/polyester blend, the dye will adhere only to the polyester fibres, leaving the wool fibres undyed. The resulting pattern will therefore be very pale and “washed out” in appearance.

Various digitally-controlled printing techniques have been adapted for printing on fabric. For example, ink-jet printers have been used for low-speed fabric printing for some years. In U.S. Pat. No. 5,801,739 a high-speed digital printing equipment is disclosed. The advantages of such direct printing equipment are said to be:

1) The time and cost savings of eliminating a plate-making stage;

2) The ability to print small runs of a particular pattern cost effectively;

3) Near-perfect colour registration, as all of the required colours can be printed in a single pass;

4) The ability to print non-repeating images of any length;

5) The potential compact size of digital fabric printers; and

6) High image resolution

This type of printer and other types are suitable for use in the present invention.

Recently equipment has become available which may be used for the digital printing of silk fabrics. The dyes used in these printers are also suitable for printing onto wool. It is therefore possible using these dyes and printing processes to produce a cue sports cloth having a printed surface pattern that includes many colours and/or subtle shades of colour, including deep/intense colours, and which does not have a washed out appearance.

We have found that a problem with surface printed woollen cloth is that, when it is used for covering a cue sports table, it can become unsightly rather quickly due to damage caused by the cue tip contacting the cloth. This damage occurs on all cue sports tables but it becomes particularly apparent when the fabric has been surface printed, because removal of the printed surface layer exposes the undyed cloth lying beneath. The problem of cue stabs occurs with all surface printed cue sports cloths, including worsted cloths, but is a particular problem with 100% woollen felted and napped cloths, since the nap is easily removed.

Cue stabs may vary in size from 1 mm and less to up to about 6 mm but tend to be of a fairly consistent depth. Any deeper stabs are likely to create a hole in the cloth, which might result in the cloth being changed. Most cue stabs are endured until they reach a certain number (or the holes are too numerous) and/or the cloth no longer has an acceptable appearance. The wear of the table is characterised by the game itself and the frequency of shots in certain directions and at certain points of the table. For example, there is generally a hard hit at the break, which often results in a cue stab in that area.

In our co-pending international patent application, publication No. WO 03/046275, we proposed to solve the problem of highly visible cue stabs by dying the bulk fabric a suitable colour before overprinting part of the cloth with a design using a digital printer. This technique is not universally suitable, particularly where the colours of the overprinting must faithfully reproduce a specification, for example when printing advertising posters onto the cloth.

Apart from damage caused by cue stabs, cue sports cloths can also be damaged or marked in various other ways, for example by cigarette bums, stains, finger prints, chalk marks and general wear.

It is an object of the present invention to provide a cue sports cloth and a method of making a cue sports cloth that mitigates at least some of the aforesaid problems.

According to the present invention there is provided a cue sports cloth comprising a cloth with a playing surface having a design printed thereon; characterised in that at least 30% of the area of the playing surface is printed with a camouflage design as defined by the function ΔE₂<k ΔE₁, where ΔE₁ is a measure of the complexity of the design as defined herein, ΔE₂ is a measure of the colour contrast of the design with respect to the base colour of the cloth as defined herein, and k is a constant with a value in the range 0 to 5.

The values ΔE₁ and ΔE₂ are defined by the equations set out below, and are measured according to the procedures set out in the examples. These procedures include in particular dividing the playing surface of the cloth into a grid of squares that measure 2″×2″ (approx. 5.08 cm×5.08 cm) and measuring the colours within each square, using the specified measuring method.

The colour complexity value ΔE₁ is defined by the equation:
ΔE₁=√((L*₁−L*₂)²+(a*₁−a*₂)²+(b*₁−b*₂)²)
where L*₁a*₁b*₁ are the colour coordinates of a first point and L*₂a*₂b₂ are the colour coordinates of a second point within each grid square, the first and second points being selected to provide a maximum colour complexity value ΔE₁.

The colour contrast value ΔE₂ is defined by the equation:
ΔE₂=√((L*₃−L*₄)²+(a*₃−a*₄)²+(b*₃−b*₄)²)
where L*₃a*₃b*₃ are the colour coordinates of the base colour of the cloth, and L*₄a*₄b*₄ are the colour coordinates of a point within each grid square that most closely matches the base colour.

We have found that designs meeting the definition specified above provide useful camouflaging properties and effectively mask any cue stabs on the surface of the cloth, so improving the visual appearance of the cloth, even when it is quite worn. Such designs also help to camouflage other marks and damage to the surface of the cloth, including burns, stains, finger prints, chalk marks and general wear. The useful lifetime of the cloth can thus be considerably extended.

Advantageously, the constant k has a value in the range 0 to 3 and preferably 0 to 2.

Advantageously, the camouflage design is further defined by a colour complexity value ΔE₁ of 15 or more, preferably 20 or more. This is particularly helpful in camouflaging other types of surface mark, such as burns, stains, finger prints and chalk marks.

Advantageously, a camouflage design is printed on at least 60%, and preferably at least 90%, of the area of the playing surface. Preferably, the camouflage design is printed on all high wear areas of the playing surface. These include in particular the areas around the D (or the head spot) and the break position.

The cloth may be a wool or wool blend fabric, containing at least 60%, preferably at least 70%, and more preferably at least 90% wool. The cloth may be a woven felted fabric, a non-woven felted fabric or a worsted fabric. Such fabrics are preferred as they generally have improved playing and/or wear characteristics as compared to other available fabrics.

Advantageously, the cloth is printed with dyes or inks applied to the surface of the base cloth. The cloth is preferably printed with a colouring agent selected from a group containing reactive dyes, acid dyes, pigments and mixtures thereof, acid dyes being particularly preferred. These dyes are compatible with woollen fabrics and it is thus possible to produce a wool or wool-blend cloth with a printed design that includes intense or deep colours, which does not have a washed out appearance.

Preferably, the cloth is printed using a computer-controlled printer, for example an inkjet printer. This makes it possible to produce complex designs with many hues and shades of colour. It is also possible to make short batch runs and one-off designs, or designs with variable information, in an economical manner.

According to a second aspect of the invention there is provided a cue sports table having a cue sports cloth as defined by any one of the preceding statements of invention.

According to a further aspect of the invention there is provided a method of printing a cue sports cloth comprising a base cloth with a playing surface; characterised in that at least 30% of the area of the playing surface is printed with a camouflage design as defined by the function ΔE₂<kΔE₁, where ΔE₁ is a measure of the complexity of the design as defined herein, ΔE₂ is a measure of the colour contrast of the design with respect to the base colour of the cloth as defined herein, and k is a constant with a value in the range 0 to 5.

Advantageously there are no solid contrasting colours in areas of the cloth that will be fitted to parts of the table that suffer from high levels of cue stab damage. One such area is around the D or head spot on a pool table. To achieve a useful degree of cue stab concealment in these highly vulnerable areas it is preferred not to allow any areas of plain and untextured cloth (i.e. without any perceptible pattern or with a value of ΔE₁ no more than 2) in colours that contrast with the base colour to be present that are larger than a size which has approximately a 50% chance of a cue stab appearing in it over the lifetime of the cloth. The size of this area will vary between types of cue sports games and even from table to table depending on the extent and type of use expected. Preferably any plain area should be less than 50 mm diameter and more preferably 10 mm diameter. Most preferably substantially no plain areas more than 5 mm diameter are positioned in areas of high risk of cue stab damage.

Advantageously the focal points of the design should lie in areas of very light cue stab damage for instance the cloth that will lie near to the pockets or on the side cushions. By focal points is meant those areas that the eye is naturally drawn towards, for example the face of a person or the whole object in the case of small motif arrangements.

Desirably, when printing a design onto a pool cloth, areas that are most vulnerable to damage are determined by mapping and the image to be printed is selected, positioned or manipulated in a design process which is predicted to reduce to a minimum the visibility of cue stabs during use of the design on the playing surface. The manipulation can take two forms. Firstly the design can be positioned so that areas of less intense pattern are sited in areas of high damage probability and areas of maximum message content or focal points are sited in areas of low damage probability. Secondly the image to be printed can be created or modified by not using block colours and by filling backgrounds and other areas with broken patterns that maintain the integrity of the colour but are broken to a degree that will camouflage any areas of light colour caused by cue stabs that reach below the level of any print penetration. Hence mosaic, swirls, clouds, bubbles or droplets that may appear in the actual design can be incorporated to effectively hide or mask the white/pale areas that would be revealed by the cue stab. The use of background breakups together with highlights in the patterning is a distinct advantage in solving the problem of cue stab visibility.

A particular design rule that we have found to give benefit is that when using the same colour hue in any given area, at least two shades should preferably be used, one lighter than the other. Cue stabs can be perceived as a lighter shade and the use of light and dark shades in close proximity effectively masks the visibility of the cue stabs. This design rule can be expressed as being that the second shade should occur within a 10 mm radius of the first shade and preferably within a 5 mm radius.

We have also found that there should advantageously be at least two further contrasting colours within a 10 mm radius of any one spot of colour: again, it is preferred for these two colours to occur within a 5 mm radius of the spot of colour. The smaller the pattern and the more areas of highlighting or high contrast or shade variation, at least in areas of high damage susceptibility, the better. Ideally the pattern and the shading combination should produce a design and shade contrast that creates sufficient visual “noise” that if a cue stab causes a lighter element to be created it is not easily discernible as damage because it blends in with the pattern and shading already present. Colour can be used to assist in this effect but it is less important than pattern and shading.

Use of a design that has a broken background, pattern or shading that creates visual noise and in particular using such a design as a background for particular brands/pictures or images is not obvious. It is far easier and simpler to use solid colour backgrounds. There are fewer issues with resolution, intricacy of the design etc. by use of solid colour backgrounds as well as the inherent advantages of less design/image/pattern manipulation.

The invention will now be further described, by way of example only, with reference to the accompanying drawings, which are briefly described as:

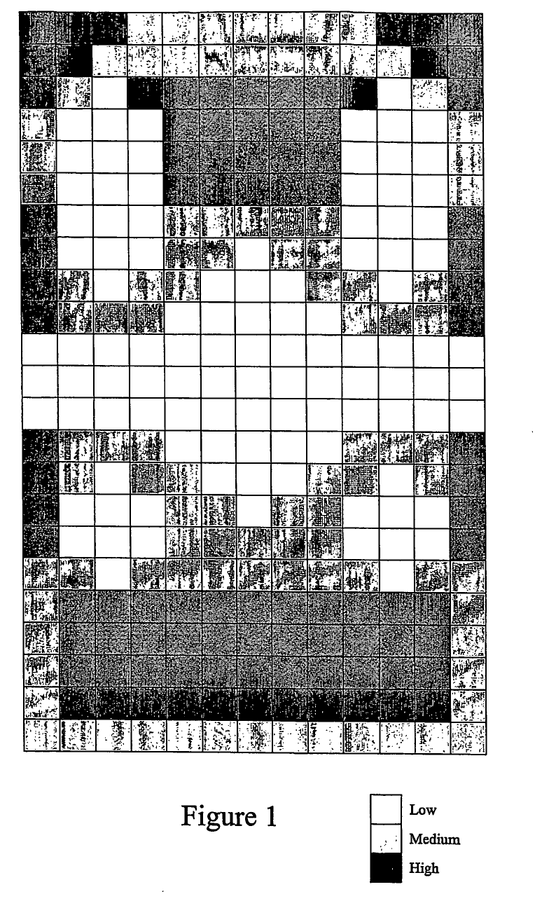

FIG. 1 is a schematic representation of a pool table cloth showing potential areas of high, low and medium cue stab damage;

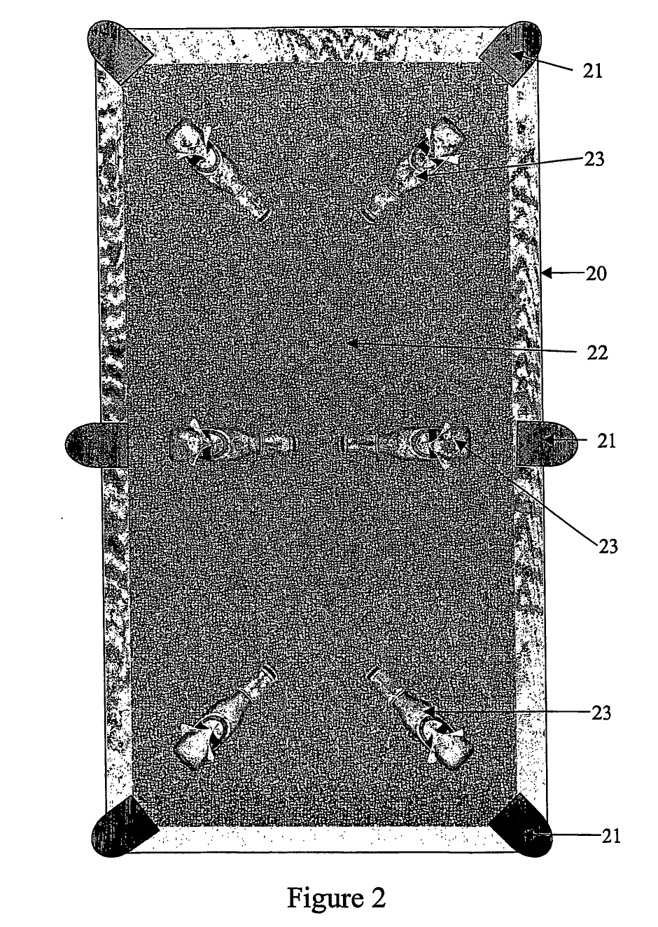

FIG. 2 shows a cloth designed and printed according to the invention;

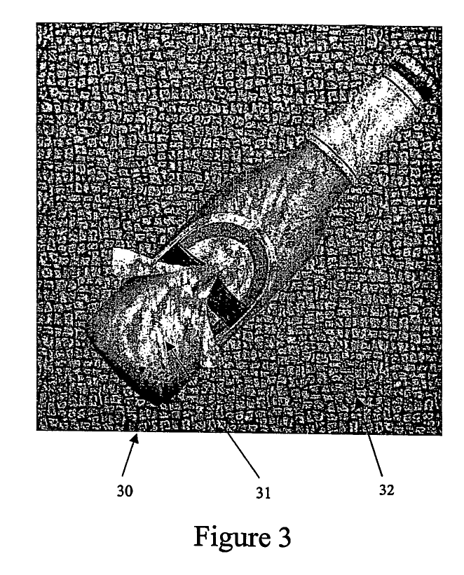

FIG. 3 is an enlarged area of one of the areas of detail showing the mosaic background;

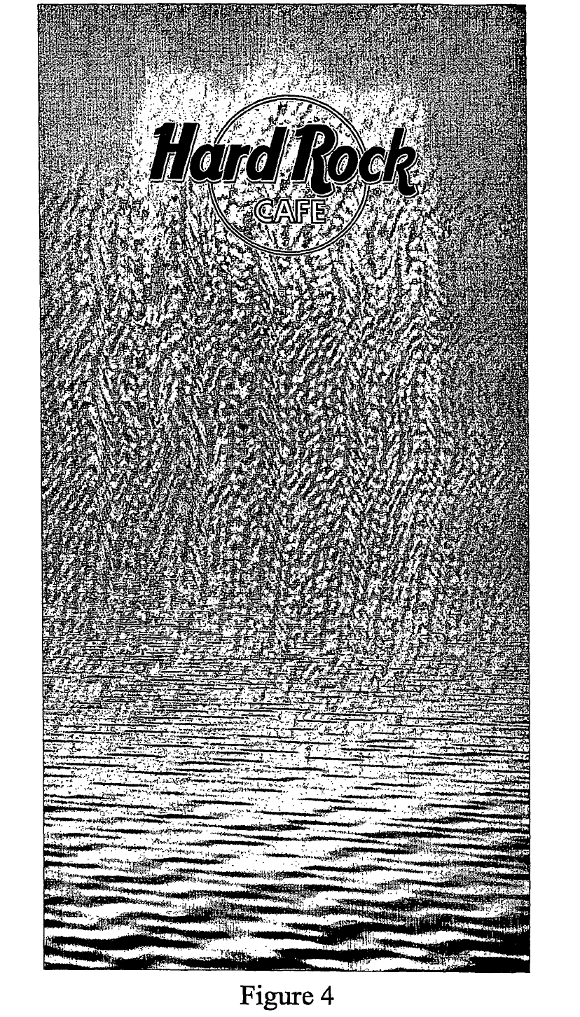

FIG. 4 is a representation of a second printed design applied to the playing surface of a cue sports cloth;

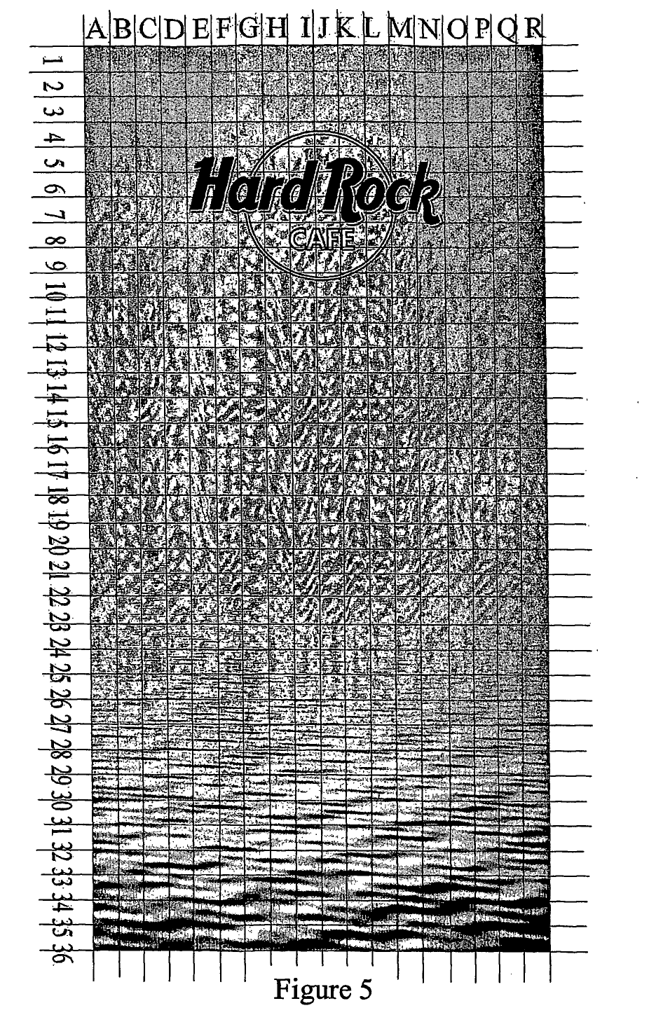

FIG. 5 is a second representation of the printed design shown in FIG. 4, superimposed with for testing purposes with a grid of squares;

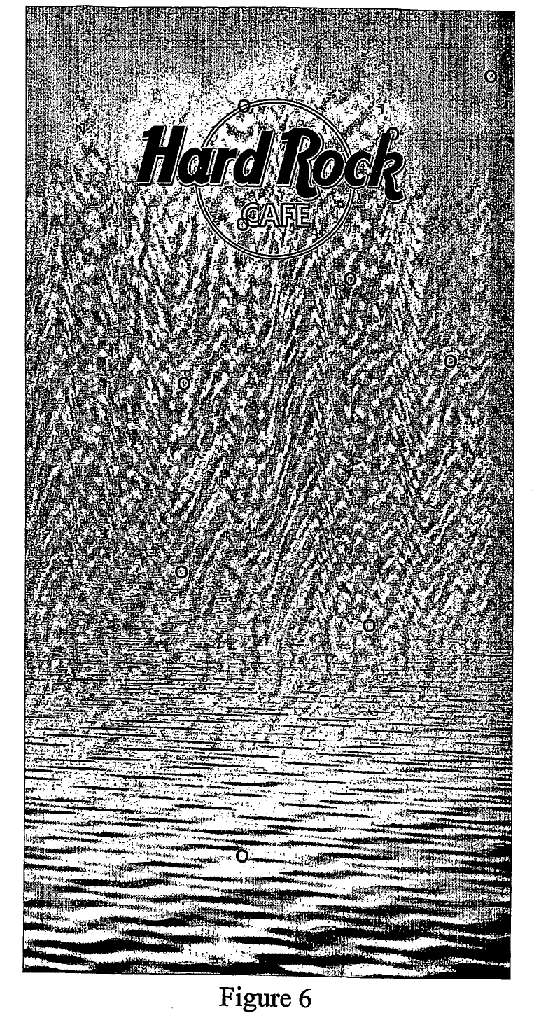

FIG. 6 is a third representation of the printed design shown in FIG. 4, which has been marked for testing purposes with a number of cue stabs (circled), and

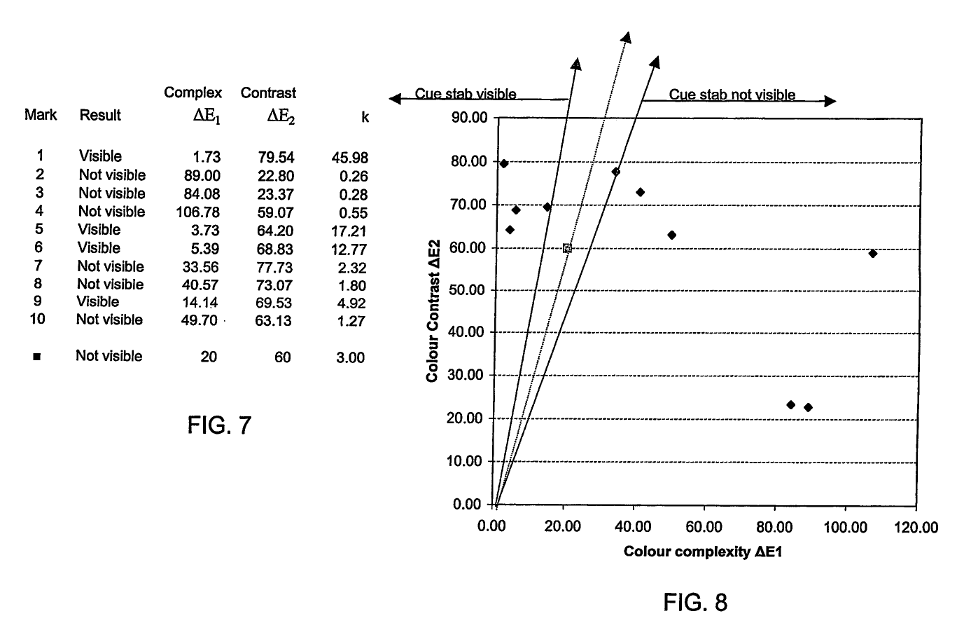

FIG. 7 is a spreadsheet and FIG. 8 is a graph of ΔE₁ against ΔE₂, showing the camouflaging effectiveness of the pattern in different squares of the grid.

The playing surface of a standard pool table typically measures 6 ft×3 ft (approx. 1.8 m×0.9 m) and is covered with a cue sports cloth. This cloth may for example be made from a woven felted fabric with a napped surface, a non-woven felted fabric or a worsted fabric. The fabric is usually made of wool or a blend of wool and synthetic fibres such as nylon. Blended fibres used for high quality cue sports cloths typically include 70-80% wool fibres and 20-30% nylon fibres.

A design may be printed onto the surface of the cloth using any suitable digital printer, such as an inkjet printer, and dyes or inks that are compatible with the fibres of the cloth, for example reactive dyes or acid dyes. The cloth maybe an undyed fabric, or it may be bulk dyed before the design is printed onto its surface.

FIG. 1 is a schematic representation of a pool table cloth with a superimposed grid of squares showing potential areas of high, low and medium cue stab damage. In the drawing, the head spot and the D are located in the lower part of the rectangle and the break position (i.e. the position of the pack of balls before breaking) is in the upper part of the rectangle. The grid squares are approximately 100 mm on each side and the shading represents the number of cue stabs that might be expected to occur in that square after a period of six months or more. “High” means that more than 3 cue stabs are likely to occur. “Low” means no more than 1 cue stab is likely to occur. It can be seen that the areas of high damage probability are around the D, around the break position and in the centres of the side cushions. Distinct areas of low damage probability occur in the centre of the table and also in areas between the centre of the table and the corner pockets and the centre pockets.

FIG. 2 shows a table 20 with pockets 21 and covered with a cloth printed according to the invention. The cloth has a background mosaic pattern 22. Adjacent each pocket 21 the cloth has been printed with a repeated object 23. Whilst in this instance the background pattern is a mosaic pattern, it could equally be a bubble pattern or any other pattern that fulfills the requirements of masking cue stab damage, at least in the areas of high levels of predicted damage.

A masking effect has been found to be created in a visually interesting way by use of a background that complements the base colour of the pool cloth. For example, this effect can be provided by use of a grass-type texture for a green cloth, clouds for a blue cloth etc.

FIG. 3 shows an enlarged view of a fragment 30 of the cloth design of FIG. 2. The detail 31 and the mosaic background 32 can be seen. A mosaic pattern is useful in achieving the objects of the invention because it provides pattern, shade and colour variation to create a visually busy background design. This background design is suitable to be applied to areas of the table cloth which are liable to suffer from high levels of stab damage as seen in FIG. 1 or similarly mapped for a different table or sport.

We have devised a set of design rules that can be used to select designs that provide a useful camouflaging effect. These rules will be explained with reference to the design shown in FIG. 4, which consists of a photographic image of a sun setting over water, superimposed with the registered trade mark HARD ROCK CAFE, and is composed primarily of red, orange and yellow colours. These colours harmonise well with the base colour of the underlying cloth, which is an undyed woven felted fabric made of 100% wool, having a natural creamy yellow colour.

The design shown in FIG. 1 includes a number of areas that provide a good camouflaging effect, so reducing the visual impact of any cue stabs in those areas. These include areas of complex design, for example in the ripples of water and around the sun, where contrasting shades or hues of colour are located in close proximity with one another, and areas where the design includes colours that are similar to the base colour of the underlying cloth (pale yellow), for example around the sun.

We have found that the effectiveness of a design in camouflaging cue stabs varies from one point to another but depends at any point on the nature of the design in the immediately surrounding area The effectiveness of the design as a whole can therefore be determined by dividing the design into a number of small areas and assessing the camouflaging effect of each of those areas.

To assess the effectiveness of the design shown in FIG. 4, the playing surface of the cloth was divided into a grid of 2″×2″ (approx. 5.08 cm×5.08 cm) squares. As the cloth was for a standard 6 ft×3 ft (approx 182.8 cm×91.4 cm) pool table, this resulted in a 36×18 grid of squares, as shown in FIG. 5.

To assess the complexity of the design in each square, a number of colour measurements were made at different points in the square, using a D65 light source and a Mercury spectrophotometer with a 2.5 mm aperture and a 10° angle of observation. These measurements were recorded using the CIE 1976 (L*a*b*) colour scheme, in which L* represents the lightness (or luminance) of the colour, a* represents the red/green colour component and b* represents the yellow/blue component. The colour measurements were then compared to find the maximum colour difference within each square: i.e. the colour difference between the two points most widely separated from one another in colour. This gave a colour complexity value ΔE₁ defined by the equation:
ΔE₁=√((L*₁−L*₂)²+(a*₁−a*₂)²+(b*₁−b*₂)²)
where L*₁a*₁b*₁ are the colour coordinates of the first point and L*₂a₂b*₂ are the colour coordinates of the second point.

This process was repeated for every square in the grid and the results were recorded in a spreadsheet. For illustrative purposes, an extract from the spreadsheet containing the colour values for one line of the grid is reproduced below:

| Grid | Colour Values 1 | | | Colour Values 2 | | | Colour Complexity |
|---|---|---|---|---|---|---|---|
| Ref. | L*₁ | a*₁ | b*₁ | L*₂ | a*₂ | b*₂ | ΔE₁ |
| 15A | 69 | 30 | 69 | 72 | 25 | 71 | 6.16 |
| 15B | 68 | 31 | 68 | 87 | −3 | 92 | 45.75 |
| 15C | 74 | 21 | 74 | 89 | −5 | 94 | 36.07 |
| 15D | 75 | 20 | 75 | 88 | −4 | 93 | 32.70 |
| 15E | 75 | 19 | 76 | 88 | −4 | 93 | 31.42 |
| 15F | 75 | 20 | 75 | 90 | −6 | 90 | 33.56 |
| 15G | 71 | 25 | 71 | 89 | −6 | 94 | 42.59 |
| 15H | 66 | 36 | 66 | 90 | −7 | 94 | 56.65 |
| 15I | 63 | 41 | 62 | 90 | −7 | 94 | 63.69 |
| 15J | 66 | 36 | 65 | 70 | 27 | 70 | 11.05 |
| 15K | 63 | 41 | 62 | 70 | 29 | 69 | 15.56 |
| 15L | 63 | 41 | 62 | 68 | 33 | 67 | 10.68 |
| 15M | 62 | 44 | 60 | 68 | 33 | 68 | 14.87 |
| 15N | 62 | 44 | 60 | 65 | 38 | 64 | 7.81 |
| 15O | 61 | 45 | 60 | 61 | 44 | 60 | 1.00 |
| 15P | 60 | 49 | 60 | 60 | 47 | 60 | 2.00 |
| 15Q | 59 | 50 | 60 | 59 | 49 | 60 | 1.00 |
| 15R | 59 | 51 | 60 | 59 | 50 | 61 | 1.41 |

The spreadsheet extract reproduced above shows the two sets of L*a*b* values and the resulting colour complexity value ΔE₁ for each square in row 15 of the grid, which passes through the centre of the sun image. As can be seen, the colour complexity value ΔE₁ varies from a minimum value of 1.0 in squares 15O and 15Q, which have very little colour complexity, to a maximum value of 63.69 in square 15I, which has a very large colour complexity, as it includes the boundary of the sun image. We have found through experimentation and testing that where the overall colour of the square is quite close to the base colour of the underlying cloth, a relatively low colour complexity value ΔE₁ is sufficient to camouflage most cue stabs. However, where the overall colour of the square contrasts strongly with the base colour, a much higher colour complexity value ΔE₁ is required.

The second aspect of the design that affects its ability to camouflage cue stabs is the colour contrast between the base colour of the underlying cloth and the colours present within each square. This is because any cue stabs tend to remove the dye from the playing surface of the cloth, exposing the colour of the underlying cloth. If the base colour of the cloth closely matches colours in the design, any cue stabs are unlikely to be seen. However, if the base colour of the cloth contrasts strongly with the colour of the printed design, any cue stabs are likely to be readily apparent (unless the design is highly complex).

To assess the colour contrast between the base colour of the cloth and the colours present in the design, the base colour of the cloth was measured by taking five spot measurements in unprinted regions of the cloth (e.g. around the edges or on the back of the cloth) and then calculating the average base colour from these readings. This colour was compared with the colour measurements already taken at various points within each square. A colour contrast value ΔE₂ representing the colour difference between the base colour and the point within the square that most closely matches the base colour was then calculated using the equation:
ΔE₂=√((L*₃−L*₄)²+(a*₃−a*₄)²+(b*₃−b*₄)²)
where L*₃a*₃b*₃ are the colour coordinates of the base colour, and L*₄a*₄b*₄ are the colour coordinates of the point within the grid square that most closely matches the base colour.

This process was repeated for every square in the grid and the results were recorded in a spreadsheet, an illustrative extract from which is reproduced below:

| Grid | Colour Values 1 | | | Colour Values 2 | | | Colour Contrast |
|---|---|---|---|---|---|---|---|
| Ref. | L*₃ | a*₃ | b*₃ | L*₄ | a*₄ | b*₄ | ΔE₂ |
| 15A | 82 | 1 | 15 | 72 | 25 | 71 | 61.74 |
| 15B | 82 | 1 | 15 | 68 | 31 | 68 | 62.49 |
| 15C | 82 | 1 | 15 | 74 | 21 | 74 | 62.81 |
| 15D | 82 | 1 | 15 | 75 | 20 | 75 | 63.32 |
| 15E | 82 | 1 | 15 | 75 | 19 | 76 | 63.98 |
| 15F | 82 | 1 | 15 | 75 | 20 | 75 | 63.32 |
| 15G | 82 | 1 | 15 | 71 | 25 | 71 | 61.91 |
| 15H | 82 | 1 | 15 | 66 | 36 | 66 | 63.89 |
| 15I | 82 | 1 | 15 | 63 | 41 | 62 | 64.58 |
| 15J | 82 | 1 | 15 | 70 | 27 | 70 | 62.01 |
| 15K | 82 | 1 | 15 | 70 | 29 | 69 | 62.00 |
| 15L | 82 | 1 | 15 | 68 | 33 | 67 | 62.64 |
| 15M | 82 | 1 | 15 | 68 | 33 | 68 | 63.47 |
| 15N | 82 | 1 | 15 | 65 | 38 | 64 | 63.71 |
| 15O | 82 | 1 | 15 | 61 | 44 | 60 | 65.69 |
| 15P | 82 | 1 | 15 | 60 | 47 | 60 | 68.01 |
| 15Q | 82 | 1 | 15 | 59 | 49 | 60 | 69.70 |
| 15R | 82 | 1 | 15 | 59 | 50 | 61 | 71.04 |

The spreadsheet extract reproduced above shows the L*a*b* values for the base colour, together with the L*a*b* values for each square in row 15 of the grid and the resulting colour contrast values ΔE₂. The colour contrast value ΔE₂ varies from a minimum value of 61.74 in square 15A, representing a low colour contrast, to a maximum value of 71.04 in square 15R, representing a stronger colour contrast. We have found through experimentation and testing that where the colour complexity of the square is quite low, a low colour contrast is required to camouflage cue stabs. Where the complexity is higher, a higher colour contrast can be permitted.

The overall camouflaging effect of the design therefore depends on both the colour complexity of the design and also the colour contrast between the base colour to the colours present within the design. To assess the relative importance of these factors, we conducted a further test by placing ten cue stab marks in random positions on the design as shown in FIG. 6 and then asking a number of individuals to try and find the cue stabs within a limited period of time. Each cue stab that was found was marked, and the squares containing those cue stabs were noted. The squares containing cue stabs that were not found were also noted. The results were plotted on a graph of ΔE₁ against ΔE₂, which is reproduced in FIG. 7.

As can be seen from the graph in FIG. 7, the cue stabs that were found were located in squares having a low value of ΔE₁, representing a low level of complexity, and a high value of ΔE₂, representing a high colour contrast. On the other hand, in squares having a high value of ΔE₁ representing a high level of complexity and a low value of ΔE₂ representing a low colour contrast, the cue stabs were well hidden.

The area of the graph representing designs that provide a good camouflaging effect can be separated from the area representing designs with poor camouflaging properties by drawing on the graph a line with a positive gradient that passes through the origin, as shown in FIG. 7. This line represents the function ΔE₂=kΔE₁, where the constant k is the gradient of the line. The area below the line represents designs with good camouflaging properties: this area is defined by the equation ΔE₂<kΔE₁.

In FIG. 7 we have shown three lines with different gradients. The line with the steepest gradient (k=4.9) represents designs that were found to provide a useful camouflaging effect. The next line (k=3.0) represents designs that provide an improved camouflaging effect and the third line (k=2.3) represents designs that provide a further improvement in the effect. From this we conclude that the constant k should have a value of about 5 or less while, for an improved camouflaging effect, the constant k should have a value of about 3 or less, and preferably 2 or less.

The above definition encompasses designs having a low colour contrast, or a high colour complexity, or both. Although all such designs provide effective protection against the appearance of cue stabs, our preference is for complex designs, since these also help to camouflage other marks on the surface of the cloth, such as chalk marks, finger prints, burns and stains. We have found that such marks can be camouflaged if the design has a colour complexity represented by a value of ΔE₁ of 15 or more, preferably 20 or more.

In order to provide adequate protection against cue stabs, at least the most vulnerable parts of the playing surface of the cloth should be provided with a pattern having good camouflaging properties. As illustrated in FIG. 1, certain parts of the cloth are more vulnerable to damage than others, the areas at most risk including the areas around the D and the breaking position. We have found that these highly vulnerable areas comprise about 30% of the total playing surface, whereas the areas of high and medium vulnerability together comprise about 60% of the playing surface. Therefore, a pattern having good camouflaging properties should be provided on at least 30% of the playing surface of the cloth, and preferably at least 60% of the playing surface, the pattern being located particularly in the areas of greatest vulnerability. More preferably, almost the whole playing surface (i.e. at least 90% of its area) should be provided with a pattern having good camouflaging properties. The design shown in FIG. 2 is a good example of such a design.

Various modifications of the invention are of course possible. For example, many different designs may be used, providing that they meet the desired design criteria as defined above. Suitable designs may include photographic or graphic art images, abstract designs, regular or irregular patterns, mosaics and so on. Various printing techniques may also be employed, although it is preferred to use a computer controlled digital printer such as an inkjet printer. The cloth on which the design is printed is preferably made of wool or a wool/synthetic fibre blend with a high wool content (e.g. greater than 60% wool). However, other fibres and blends may also be used. The fabric is preferably a woven felt with a napped surface or a worsted fabric, although other fabrics, including knitted, felted, woven and non-woven fabrics may also be used.

1. A cue sports cloth comprising a cloth with a playing surface having a design printed thereon; characterised in that at least 30% of the area of the playing surface is printed with a camouflage design as defined by the function ΔE₂<kΔE₁, where ΔE₁ is a measure of the complexity of the design as defined herein, ΔE₂ is a measure of the colour contrast of the design with respect to the base colour of the cloth as defined herein, and k is a constant with a value in the range 0 to 5.

2. A cue sports cloth according to claim 1, wherein the constant k has a value in the range 0 to 3 and preferably 0 to 2.

3. A cue sports cloth according to claim 1 or claim 2, wherein the camouflage design is further defined by a colour complexity value ΔE₁ of 15 or more, preferably 20 or more.

4. A cue sports cloth according to any preceding claim, wherein a camouflage design is printed on at least 60%, and preferably at least 90%, of the area of the playing surface.

5. A cue sports cloth according to any preceding claim, wherein a camouflage design is printed on all high wear areas of the playing surface.

6. A cue sports cloth according to any preceding claim, wherein the cloth is a wool or wool blend fabric, containing at least 60%, preferably at least 70%, and more preferably at least 90% wool.

7. A cue sports cloth according to any preceding claim, wherein the cloth is a woven felted fabric.

8. A cue sports cloth according to any one of claims 1 to 6, wherein the cloth is a non-woven felted fabric.

9. A cue sports cloth according to any one of claims 1 to 6, wherein the cloth is a worsted fabric.

10. A cue sports cloth according to any preceding claim, wherein the cloth is printed with dyes or inks applied to the surface of the base cloth.

11. A cue sports cloth according to any preceding claim, wherein the cloth is printed with a colouring agent selected from a group containing reactive dyes, acid dyes, pigments and mixtures thereof.

12. A cue sports cloth according to claim 11, wherein the cloth is printed with acid dyes.

13. A cue sports cloth according to any preceding claim, wherein the cloth is printed by inkjet printing.

14. A cue sports table having a cue sports cloth as defined by any one of the preceding claims.

15. A method of printing a cue sports cloth comprising a base cloth with a playing surface; characterised in that at least 30% of the area of the playing surface is printed with a camouflage design as defined by the function ΔE₂<kΔE₁, where ΔE₁ is a measure of the complexity of the design as defined herein, ΔE₂ is a measure of the colour contrast of the design with respect to the base colour of the cloth as defined herein, and k is a constant with a value in the range 0 to 5.

16. A method according to claim 15, wherein the constant k has a value in the range 0 to 3 and preferably 0 to 2.

17. A method according to claim 15 or claim 16, wherein the camouflage design is further defined by a colour complexity value ΔE₁ of 15 or more, preferably 20 or more.

18. A method according to any one of claims 15 to 17, wherein a camouflage design is printed on at least 60%, and preferably at least 90%, of the area of the playing surface.

19. A method according to any one of claims 15 to 18, wherein a camouflage design is printed on all high wear areas of the playing surface.

20. A method according to any one of claims 15 to 19, wherein the cloth is a wool or wool blend fabric, containing at least 60%, preferably at least 70%, and more preferably at least 90% wool.

21. A method according to any one of claims 15 to 20, wherein the cloth is a woven felted fabric.

22. A method according to any one of claims 15 to 20, wherein the cloth is a non-woven felted fabric.

23. A method according to any one of claims 15 to 20, wherein the cloth is a worsted fabric.

24. A method according to any one of claims 15 to 23, wherein the cloth is printed with dyes or inks applied to the surface of the base cloth.

25. A method according to any one of claims 15 to 24, wherein the cloth is printed with a colouring agent selected from a group containing reactive dyes, acid dyes, pigments and mixtures thereof.

26. A method according to claim 25, wherein the cloth is printed with acid dyes.

27. A method according to any one of claims 15 to 26, wherein the cloth is printed by inkjet printing.

28. A cue sports cloth printing method comprising designing the pattern to be applied such that there are substantially no areas of plain colour more than 150 mm diameter in substantially all locations on the table which sustain high levels of cue stab damage as hereinbefore defined.

29. A method according to claim 28, in which at least two further colours are found within a 10 mm radius of substantially any spot of a colour in substantially all areas of the cloth in locations that suffer from cue stab damage to a medium or high extent as hereinbefore defined.

30. A method according to claim 28 or claim 29 wherein at least one further shade of a colour is found within a 10 mm radius of substantially any spot of colour in substantially all areas of the cloth in locations that suffer from cue stab damage to a low extent as hereinbefore defined.
